(19) United States
(12) Patent Application Publication
(10) Pub. No.: US 2005/0232605 A1
(43) Pub. Date: Oct. 20, 2005

(54) Data recording and reproduction apparatus and method thereof

(76) Inventor: Nobuhiro Chiba, Kanagawa (JP)

Correspondence Address: BELL, BOYD & LLOYD, LLC, P. O. BOX 1135, CHICAGO, IL, 60690-1135, US

(21) Appl. No.: 11/152,500

(22) Filed: Jun. 14, 2005

Related U.S. Application Data
(63) Continuation of application No. 09/314,783, filed on May 19, 1999, now abandoned.

(30) Foreign Application Priority Data
May 19, 1998 (JP) P10-136887

(51) Int. Cl. H04N 5/781

(52) U.S. Cl. 386/108; 386/125

(57) ABSTRACT

This invention relates to a data recording and reproduction apparatus, wherein video data VD and audio data AD are recorded in a recording medium while they are mixed in a compressed state respectively, and are reproduced from this recording medium. The video data is recorded in a recording medium in units of a predetermined length, and subsequently thereto, the audio data is recorded in the recording medium in units of a predetermined length. To each head portion of the video data and audio data, header data VH and AH, which are identification information for identifying these data, are added. When the video data and audio data recorded at different areas in the recording medium are reproduced, the access time is shortened by making the head seeking operation on the basis of the header data and reducing the number of seeking operation.

### CROSS REFERENCE TO RELATED APPLICATIONS

The present application is a continuation of U.S. patent application Ser. No. 09/314,783 filed on May 19, 1999, and which claims priority to Japanese Patent Application No. P10-136887 filed on May 19, 1999, the above-referenced disclosures of which are herein incorporated by reference.

### BACKGROUND OF THE INVENTION

1. Field of the Invention

The present invention relates to a data recording and reproduction apparatus for recording and reproducing video data, audio data and the like using a hard disk driving apparatus or the like, and a method therefor. More particularly, the invention relates to a data recording and reproduction apparatus for reducing a number of head seekings to recording and reproduction means by adding, when recording video data, audio data and the like are recorded, the identification information (header data) for identifying video data, audio data and the like to data head portions of the video data, audio data and the like for recording, and only by detecting identification information, even when video data, audio data and the like are separately edited.

2. Description of the Related Art

Recently, a hard disk driving apparatus, in which a random-accessible hard disk and the like are used as a recording medium, has often been used as a data recording and reproduction apparatus for recording and reproducing video data, audio data and the like.

Video data and audio data are normally recorded in a compressed state and yet in a mixed state in one data stream, and therefore, the video data and the audio data must be extracted and separated. As a recording format for data, identification information for the video data VD, that is, header data VH and identification information for audio data AD, that is, header data AH, are inserted into the head portion of the data, as shown in FIG. 1.

In the example shown in FIG. 1, since the data are arranged in the order from the video data VD to the audio data AD, the identification information to be inserted at the head is also set to such a format that the header data VH for the video data is first inserted and the header data AH for the audio data is next inserted.

These header data are used for reproducing the video data VD and the audio data AD, and a case where data recorded in such format as shown in FIG. 1 is reproduced to separately edit the video data and the audio data, will be described with reference to FIG. 2.

In FIG. 2A, a source S represents video data VD and audio data AD, which are recorded in a recording medium. In the case of the FIG. 2A, it is assumed that video data VD1 and audio data AD1 are recorded in an area 1, and that video data and audio data (VD2, AD2) to (VD4, AD4) are, hereinafter similarly, recorded in areas 2, 3 and 4 respectively, in accordance with the recording format of FIG. 1. An area 5 designates a space area.

The video data VD and the audio data AD are read out respectively from such a source, and it is assumed that the video data VD will be, as shown in FIG. 2B, edited so that the video data VD1, VD2 and VD4, which are recorded in the areas 1, 2 and 4, may continue, and that the audio data AD will be, as shown in FIG. 2C, edited so that the audio data AD1, AD3 and AD4, which are recorded in the areas 1, 3 and 4, may continue.

In the case of reading out the video data VD and the audio data AD from different areas, it is necessary to simultaneously read out also header data VH and AH accompanied by the video data VD and the audio data AD, respectively. For this reason, it is necessary, in the area 2 portion, to read out the video header data VH2 and the video data VD2 and it is necessary, in the area 3 portion, to read out the video header data AH3 and the audio data AD3.

Since the audio header data AH3 in the area 3 is recorded at the front of the video data VD3 within the same area as shown in FIG. 3, the head is moved to the area 3 by seeking the head after the video header data VH2 and its video data VD2 in the area 2 have been reproduced, and then the audio header data AH3 is reproduced and thereafter audio data AD3 in the area 3 is reproduced by seeking the head again. This is because since the data length of the video data VD3 recorded in the area 3 is comparatively long, the audio header data AH3 is often recorded at a distance from the audio data AD3, and as a result, the audio data AD3 cannot be reproduced continuously, without changing the reproduction mode as it is, immediately after the audio header data AH3 is reproduced.

With the conventional apparatus as described above, in every time when the video data VD and the audio data AD are read out from a plurality of areas, a seeking operation must be executed several times. In a case where a hard disk is used as the recording medium, the access time may take about 20 msec at maximum to reach the desired area when the head seeking operation is made, said access time consisting of head seeking time and rotation waiting time. In other words, this is very disadvantageous in consideration of this access time to the reproduction of the video data VD and the audio data AD for which real-time property is requested.

### SUMMARY OF THE INVENTION

The present invention has been achieved to solve such conventional problems, and is aimed to provide a data recording and reproduction apparatus capable of shortening access time of the head and a method therefor.

In order to solve the above-described problems, according to first aspect of the present invention, there is provided a data recording and reproduction method for recording first data and second data, which is different from the first data, in a recording medium while they are mixed in a compressed state respectively, and for reproducing the data from this recording medium. In the data recording and reproduction method, first data is recorded on the recording medium in units of a predetermined length. The second data is recorded on the recording medium in units of a predetermined length, subsequently to this first data. These first and second data are recorded in a state in which identification information for identifying these data is added to each head portion of the first and second data.

Further, according to another aspect of the present invention, there is provided a data recording and reproduction apparatus for recording and reproducing data. The data recording and reproduction apparatus comprises a first encoder for encoding first data, a second encoder for encoding second data, an interface circuit for arranging the encoded first and second data in a predetermined order in a state in which respective identification data have been added to each head portion of the first and second data, recording and reproduction means for recording these first and second data, and first and second decoders for decoding the first and second data reproduced by this recording and reproduction means.

In the data recording and reproduction apparatus, the first and second data are reproduced on the basis of the identification data.

According to the present invention, by adopting such a recording format as shown in FIG. 5, identification information for extracting and separating the recording data is added to the head portion of the recording data. Therefore, the video header data VH2 and the subsequent video data VD2 in area 2 are continuously reproduced as shown in FIG. 6, for example, and then the seeking operation is made to retrieve the audio header data AH3 in the area 3. When the audio header data AH3 can be reproduced, the audio data AD3 is reproduced subsequently. Thus, even when data are reproduced from two or more areas, the number of seekings is reduced.

Other objects and advantages of the invention will become apparent during the following discussion of the accompanying drawings.

### BRIEF DESCRIPTION OF THE FIGURES

FIG. 1 is a view showing a recording data format of related art;

FIGS. 2A, 2B and 2C are views showing an example of data reproduction;

FIG. 3 is a view for explaining the seeking operation in the related art;

FIG. 4 is a system diagram showing a principal part of a data recording and reproduction apparatus as an embodiment according to the present invention;

FIG. 5 is a view showing a recording data format using for this invention; and

FIG. 6 is a view for explaining a seeking operation of the invention.

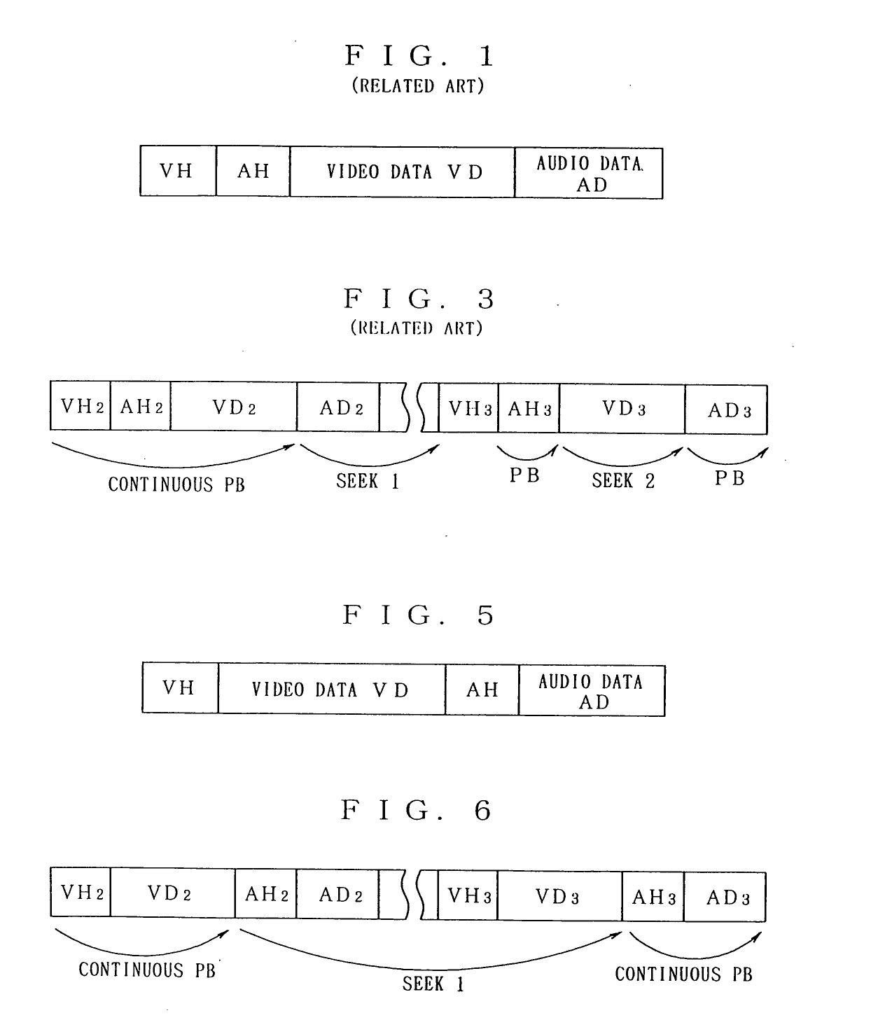

### DETAILED DESCRIPTION OF THE INVENTION

With reference to the drawings, the detailed description will be made of a data recording and reproduction apparatus and its method as an embodiment according to the present invention.

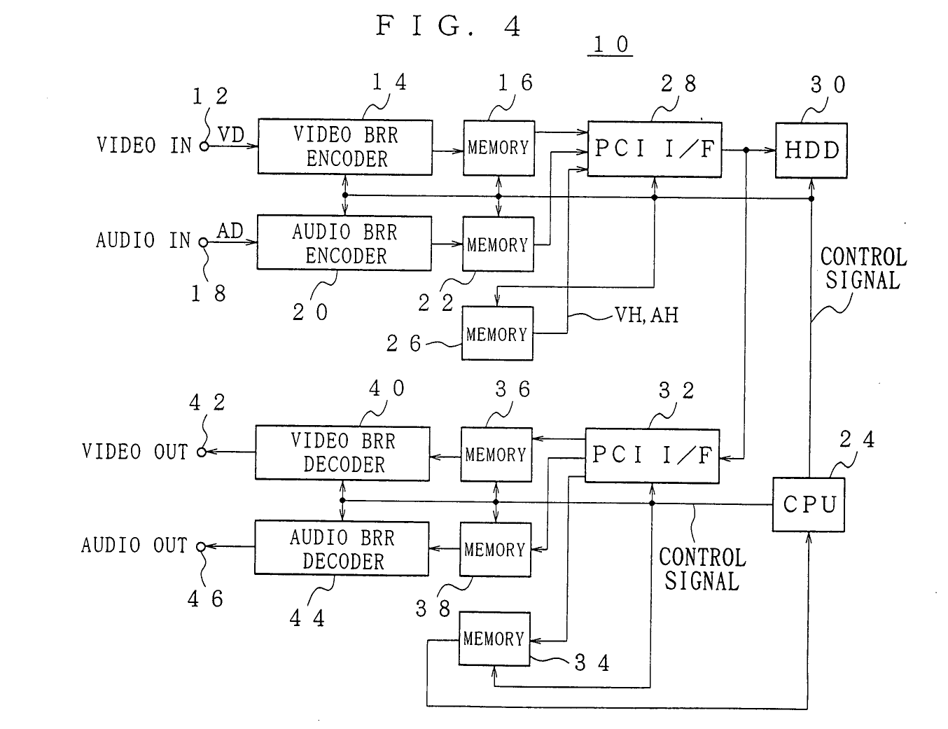

FIG. 4 shows a data recording and reproduction apparatus 10 using a hard disk as the recording medium as an embodiment of the invention.

First, the structure of the data recording system will be described. A video encoder 14 is an encoder for bit rate reduction (BRR) to compress input video data VD. The video data VD thus compressed is saved in a memory 16. Similarly, an audio encoder 20 is also an encoder for bit rate reduction (BRR) to compress input audio data AD. The audio data AD thus compressed is saved in a memory 22.

A memory 26 saves the identification information (header data) VH, AH each for the video data VD and the audio data AD.

The video data HD, the audio data AD and the respective header data VH, AH, which have been read out from the memories 16, 22 and 26 respectively, are recorded in recording and reproduction means 30 through an interface 28. A PCI (Peripheral Component Interconnect) bus is illustrative of a data bus. For the recording and reproduction means 30, a hard disk having large memory capacity or the like can be used as a recording medium. Recording and reproduction means of RAID (Redundant Arrays Inexpensive disks) system having a plurality of hard disk devices used in parallel may be used as storing means having a very larger memory capacity.

Any of the above-described encoders 14, 20, memories 16, 22, 26, interface circuit 28 and recording and reproduction means 30 is controlled by a control unit 24 having CPU. For any of the memories 16, 22 and 26, RAM or the like is used.

The structure of the data reproduction system will be described. The video data VD, the audio data AD and the header data VH, AH read out from the recording and reproduction means 30 respectively. The video data VD is stored on the memory 36 through the interface circuit 32. The audio data AD is stored on the memory 38 through the interface circuit 32, and the respective header data VH, AH are stored on the memories 34 through the interface circuit 32. A video decoder 40 is a decoder for bit rate reduction, and expands video data VD read out from the memory 36. Similarly, the audio decoder 44 is also a decoder for bit rate reduction, and expands audio data AD read out from the memory 38. The control unit 24 controls decoding timing and the like on the basis of the header data VH, AH read out from the memory 34.

The recording and reproduction operation will be described. The video data VD supplied to a terminal 12 is compressed by the video encoder 14 constituted by an encoder circuit. In video encoder of this example, the video data VD is compressed by a MPEG (Moving Picture of Editing Groups) system using frame-to-frame correlation. In order to compress the data, a data compression system (DV system) which does not use the frame correlation may be used.

The input audio data AD supplied to a terminal 18 is also similarly compressed by the audio encoder 20 constituted by an encoding circuit, and thereafter, is written in the memory 22.

Any of the recording and reproduction operation is controlled on the basis of a control signal from the control unit 24 constituted by CPU. Further, this control unit 24 transmits header data, which is identification information for the video data VD and the audio data AD, and said header data thus transmitted is written into the memory 26 for header data. The video data VD and the audio data AD are reproduced on the basis of the header data.

The video data VD, the audio data AD and the header data DH, AH, which are written in these memories 16, 22 and 26, are read out in accordance with a command from the control unit 24 to be supplied to the interface circuit 28.

In the interface circuit 28, the data are reformed to such a recording data format as shown in FIG. 5. More specifically, according to the present invention, when the video data VD and the audio data AD are recorded and reproduced in a mixed state, identification information is added in order to enable these video data VD and audio data AD to be extracted and separated. On adding this identification information, identification information relating to these data are added to the head portions of the respective data as shown in FIG. 5.

In a case where the types of the object data are, for example, video data VD and audio data AD as described above, the header data (video header data) VH for the video data VD compressed is first inserted into the head portion of the video data VD. The audio data AD compressed follows the video data VD, and the audio header data AH for this audio data AD is inserted into the head portion of the audio data AD.

When the video data VD and the audio data AD are compressed by the MPEG system respectively, the video data VD is arranged in units of 1 GOP (Group of Picture). In this case, as the video header data VH, start address and the like of I picture, P picture and B picture of GOP are used.

The audio data AD is compressed data based on the MPEG audio format, and the audio header data AH used at the time is audio address, a number of audio frames, or the like. As required, information such as bit rate and emphasis may be added.

Recording signals containing header data reformed in accordance with such a recording data format as shown in FIG. 5 are transferred to the recording and reproduction means 30 to be recorded in a predetermined area.

When these recording data, which constitute a source, is read out, the control unit 24 instructs the interface circuit, or the PCI interface circuit 32 in this example, to read out these recording data using video and audio header data VH, AH. Thus, the recording and reproduction means 30 reads out the recording data designated. At the same time, the video data VD read out is written in the corresponding memory 36. Similarly, the audio data AD read out is written into the memory 38, and the video and audio header data VH, AH added respectively are written in the memory 34.

The header data VH, AH written in the memory 34 for header data are returned to the control unit 24 to be used as control data for reading out the header data from the memories 36, 38. Therefore, when the control unit 24 transmits the designated header data to the interface circuit 32, the video data VD is read out from the memory 36 and then the data compressed is restored in a decoding circuit 40 for bit rate reduction (BRR). Thus, the video data VD (video signal) restored is obtained at an output terminal 42. Similarly, the audio data AD is read out from the memory 38 and then the audio data AD compressed is restored in a decoding circuit 44 for bit rate reduction (BRR) to be outputted at a terminal 46 as an audio signal.

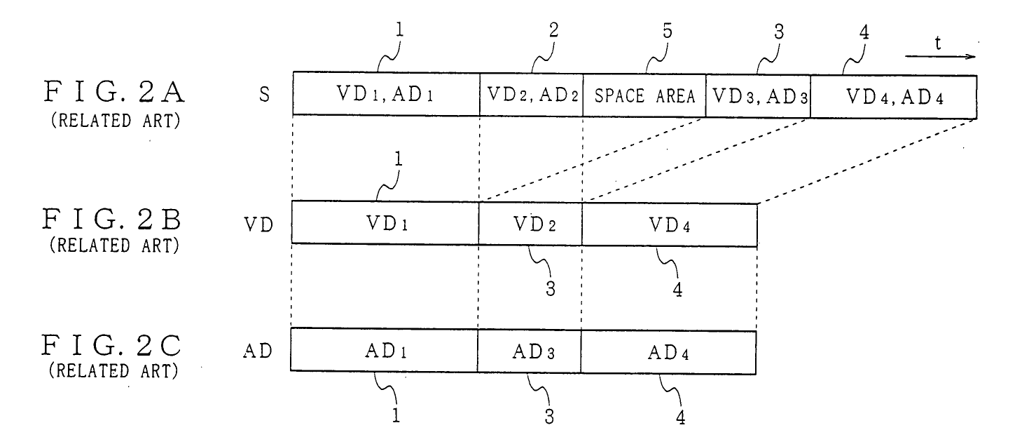

Hereinafter, the description will be made of an editing process according to the present invention, particularly a case where video data VD and audio data AD are separately edited. For convenience' sake in description, there will be described recording data in which video data VD1 to VD4 and audio data AD1 to AD4 are mixedly recorded in areas 1, 2, 3 and 4 respectively, as shown in FIG. 2A. It is assumed that video data VD2 and audio data AD3 are reproduced particularly from area 2 and area 3 as shown in FIGS. 2B and 2C.

In this case, in order to reproduce the video data VD2 at first, the video header data VH2 added at the front of the video data VD2 is reproduced in addition to the video data VD2 as shown in FIG. 6. Since the video data VD2 and the video header data VH2 are continuously recorded, the video header data VH2 and the video data VD2 are continuously reproduced in this order.

Next, in order to reproduce the audio data AD3 in the area 3, a seeking operation is made at a stage at which the reproduction of the video data VD2 has been completed, and the head is caused to move at high speed to the audio head data AH3 within the area 3. Thereafter, the audio header data AH3 and the audio data AD3 are continuously reproduced in this order.

Thus, the video data VD and the audio data AD can be reproduced respectively from the areas 2 and 3, only by one head seeking operation. In other words, at least two seeking operations have been required to reproduce those data as shown in FIG. 3 conventionally, but only one seeking operation is sufficient for the reproduction according to the invention. Therefore, the head access time can be shortened to ½ or less.

Since the access time can be shortened, consequently video data VD of high image quality and audio data AD of high sound quality, which are that much higher in data rate, can be recorded respectively. Alternatively, in a case where recording and reproduction for a plurality of channels are performed, more channels can be recorded and reproduced because there is provided room for access by the time corresponding to the seeking time thus shortened.

In the above-described embodiment, the description has been made of the case where the video data VD is arranged in units of 1 GOP, but it is also possible to arrange the video data VD in units of, for example, one line of video frame.

In the above-described example, the description has been made of the example in which a hard disk device is used as video and audio recording and reproduction means 30, but it is also possible to use an optical disk device, semiconductor memory, a cassette auto-changer device, a disk auto-changer device or the like, or any of their combinations. Also, the description has been made of a case using the PCI interface circuits 28 and 32 as the interface, but SCSI (Small Computer System Interface) or other interfaces can be used. In the above-described example, as the first and second data, the description has been made by dividing into two: video data VD and audio data AD. However, in the case of recording data different from them, it is possible to similarly insert the header data into the recording data head by bringing the header data into correspondence with the recording data and record said data.

As described above, in the present invention, identification information for identifying data is added to respective heads of recording data such as video data and audio data for recording.

According to this system, even when video data, audio data and the like are separately edited, it becomes possible to reproduce the desired video data and the like without necessitating any extra access. Thus, the access time can be shortened, and recording and reproduction can be performed in high image quality and in high sound quality, which are higher in data rate by the amount corresponding to this shortened access time.

Having described out invention as related to the embodiments shown in the accompanying drawings, it is our intention that the invention be not limited by any of the details of description, unless otherwise specified, but rather be constructed broadly within its spirit and scope as set out in the accompanying claims.

1. A data recording and reproduction method for recording first data and second data, which is different from said first data, in a recording medium while they are mixed in a compressed state respectively, and for reproducing from said recording medium, comprising the steps of:
compressing said first data with a first data encoder, said first data encoder including an MPEG compression system;
compressing said second data with a second data encoder, said second data encoder including an MPEG compression system;
recording said first data in said recording medium in units of a predetermined length, and subsequently to said first data, recording said second data in said recording medium in units of a predetermined length, and
recording these first and second data in a state in which identification information for identifying these data are added to each head portion of said first and second data thereby allowing retrieval of the first data and the second data in addition to corresponding identification information in a continuous manner.

2. A data recording and reproduction method according to claim 1, wherein when said first and second data recorded at different areas in said recording medium are retrieved, a head seeking operation is made on the basis of said identification information, whereby head access time can be shortened.

3. The method according to claim 1, wherein the first data is video data, the second data is audio data, and wherein the MPEG compression system of the first data encoder is operable to utilize frame-to-frame correlation and to arrange the first data in units of 1 GOP.

4. A data recording and reproduction system, comprising:
a first encoder for encoding first data, wherein said first encoder includes an MPEG compression system;
a second encoder for encoding second data, wherein said second encoder includes an MPEG compression system;
an interface circuit for arranging said encoded first and second data subsequent to said encoded first data in which respective identification data are added to each head portion of said encoded first and second data;
recording and reproduction means for recording these first and second data allowing retrieval of the first and second data in addition to respective identification data in a continuous manner for reproduction purposes.
first and second decoders for decoding first and second data reproduced from said recording and reproduction means,
wherein said first and second data are reproduced on the basis of said identification data.

5. A data recording and reproduction system according to claim 4, wherein said recording and reproduction means is disk recording and reproduction means using a hard disk.

6. A data recording and reproduction system according to claim 4, wherein said first data is video data, said second data is audio data, and wherein the MPEG compression system of the first data encoder is operable to utilize frame-to-frame correlation and to arrange the first data in units of 1 GOP.
